(19) United States
(12) Patent Application Publication
(10) Pub. No.: US 2023/0377225 A1
(43) Pub. Date: Nov. 23, 2023

(54) METHOD AND APPARATUS FOR EDITING AN IMAGE AND METHOD AND APPARATUS FOR TRAINING AN IMAGE EDITING MODEL, DEVICE AND MEDIUM

(71) Applicant: Beijing Baidu Netcom Science and Technology Co., Ltd., Beijing (CN)

(72) Inventors: Chengquan ZHANG, Beijing (CN); Yuechen YU, Beijing (CN); Liang WU, Beijing (CN)

(21) Appl. No.: 18/121,444

(22) Filed: Mar. 14, 2023

(30) Foreign Application Priority Data
May 19, 2022 (CN) 202210556462.6

(51) Int. Cl. G06T 11/60; G06V 20/62; G06V 10/82; G06V 30/19; G06V 30/14

(52) U.S. Cl. CPC G06T 11/60; G06V 20/62; G06V 10/82; G06V 30/19127; G06V 30/1918; G06V 30/1444; G06V 30/19147; G06V 40/10

(57) ABSTRACT

A method for training an image editing model includes steps described below. Covering processing is performed on a region of interest determined in an original image so that a background image sample is formed, and content corresponding to the region of interest is determined as a sample of content of interest; the background image sample and the sample of the content of interest are input into an image editing model; fusion processing is performed on a background image feature and a feature of the region of interest by using the image editing model so that a fusion feature is formed; an image reconstruction operation is performed according to the fusion feature by using the image editing model so that a reconstructed image is output; and optimization training is performed on the image editing model according to a loss relationship between the reconstructed image and the original image.

### CROSS-REFERENCE TO RELATED APPLICATION

This application claims priority to Chinese Patent Application No. CN202210556462.6, filed on May 19, 2022, the disclosure of which is incorporated herein by reference in its entirety.

### TECHNICAL FIELD

The present disclosure relates to the technical field of artificial intelligence, in particular, to the technical field of deep learning, image processing and computer vision, and may be applied to an optical character recognition (OCR) scene.

### BACKGROUND

Application scenes such as advertisement picture editing, photographed document handwriting removing and augmented reality (AR) translation all require image editing processing. For example, text in an image needs to be translated, text in an image needs to be hidden or removed, or a part of an image needs to be adjusted.

To improve the degree of automation of image editing processing, image processing may be performed based on a machine learning model in the related art. However, to satisfy specific image processing requirements, the machine learning model needs to be trained through sufficient training samples.

The preceding related art generally strongly depends on the amount and authenticity of training sample data, but it is difficult to acquire paired data in real data scenes and the cost of manual marking is high.

### SUMMARY

The present disclosure provides a method and apparatus for editing an image, a method and apparatus for training an image editing model, a device and a medium.

According to an aspect of the present disclosure, a method for training an image editing model is provided. The method includes steps described below.

Covering processing is performed on a region of interest determined in an original image so that a background image sample is formed, and content corresponding to the region of interest is determined as a sample of content of interest.

The background image sample and the sample of the content of interest are input into an image editing model so that a background image feature is extracted from the background image sample and a feature of the region of interest is extracted from the sample of the content of interest, respectively.

Fusion processing is performed on the background image feature and the feature of the region of interest based on a position of the region of interest in the original image by using the image editing model so that a fusion feature is formed.

An image reconstruction operation is performed according to the fusion feature by using the image editing model so that a reconstructed image is output.

Optimization training is performed on the image editing model according to a loss relationship between the reconstructed image and the original image by using the original image as a supervision result.

According to another aspect of the present disclosure, a method for editing an image is provided. The method includes steps described below.

A region of interest in a to-be-edited image and editing content for processing in the region of interest are determined.

Covering processing is performed on the region of interest in the to-be-edited image so that a background image is formed.

The background image, the editing content and a position of the region of interest in the to-be-edited image are into an image editing model, and editing processing is performed on an image of the region of interest by using the editing content.

The image editing model is obtained by training through the method for training an image editing model according to any embodiment of the present disclosure.

According to another aspect of the present disclosure, an apparatus for training an image editing model is provided. The apparatus includes a sample generation module, a feature extraction module, a feature fusion module, an image reconstruction module and a model supervision module.

The sample generation module is configured to perform covering processing on a region of interest determined in an original image to form a background image sample, and determine content corresponding to the region of interest as a sample of content of interest.

The feature extraction module is configured to input the background image sample and the sample of the content of interest into an image editing model to extract a background image feature from the background image sample and a feature of the region of interest from the sample of the content of interest, respectively.

The feature fusion module is configured to perform fusion processing on the background image feature and the feature of the region of interest based on a position of the region of interest in the original image by using the image editing model to form a fusion feature.

The image reconstruction module is configured to perform an image reconstruction operation according to the fusion feature by using the image editing model to output a reconstructed image.

The model supervision module is configured to perform optimization training on the image editing model according to a loss relationship between the reconstructed image and the original image by using the original image as a supervision result.

According to another aspect of the present disclosure, an apparatus for editing an image is provided. The apparatus includes an editing content determination module, a background image forming module and an image editing processing module.

The editing content determination module is configured to determine a region of interest in a to-be-edited image and editing content for processing in the region of interest.

The background image forming module is configured to perform covering processing on the region of interest in the to-be-edited image to form a background image.

The image editing processing module is configured to input the background image, the editing content and a position of the region of interest in the to-be-edited image into an image editing model, and perform editing processing on an image of the region of interest by using the editing content.

The image editing model is obtained by training through the method for training an image editing model according to any embodiment of the present disclosure.

According to another aspect of the present disclosure, an electronic device is provided. The electronic device includes at least one processor and a memory communicatively connected to the at least one processor.

The memory stores instructions executable by the at least one processor to enable the at least one processor to execute the method for training an image editing model according to any embodiment of the present disclosure or the method for editing an image according to any embodiment of the present disclosure.

According to another aspect of the present disclosure, a non-transitory computer-readable storage medium is provided. The storage medium stores computer instructions for causing a computer to execute the method for training an image editing model according to any embodiment of the present disclosure or the method for editing an image according to any embodiment of the present disclosure.

According to another aspect of the present disclosure, a computer program product is provided. The computer program product includes a computer program. When the computer program is executed by a processor, the method for training an image editing model according to any embodiment of the present disclosure or the method for editing an image according to any embodiment of the present disclosure is implemented.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the solutions and not to limit the present disclosure.

FIG. 1A is a schematic diagram of a method for training an image editing model according to an embodiment of the present disclosure;

FIG. 1B is a schematic diagram showing the flow of training an image editing model according to an embodiment of the present disclosure;

FIG. 1C is a schematic diagram showing the flow of using an image editing model according to an embodiment of the present disclosure;

FIG. 2 is a schematic diagram of a method for training an image editing model according to another embodiment of the present disclosure;

FIG. 3 is a schematic diagram of a method for training an image editing model according to another embodiment of the present disclosure;

FIG. 4 is a schematic diagram of a method for editing an image according to an embodiment of the present disclosure;

FIG. 5 is a schematic diagram of a method for editing an image according to another embodiment of the present disclosure;

FIG. 6 is a schematic diagram of an apparatus for training an image editing model according to an embodiment of the present disclosure;

FIG. 7 is a schematic diagram of an apparatus for editing an image according to an embodiment of the present disclosure; and

FIG. 8 is a block diagram of an electronic device for implementing a method according to an embodiment of the present disclosure.

### DETAILED DESCRIPTION

Example embodiments of the present disclosure, including details of embodiments of the present disclosure, are described hereinafter in conjunction with drawings to facilitate understanding. The example embodiments are illustrative only. Therefore, it is to be appreciated by those of ordinary skill in the art that various changes and modifications may be made to the embodiments described herein without departing from the scope and spirit of the present disclosure. Similarly, description of well-known functions and constructions is omitted hereinafter for clarity and conciseness.

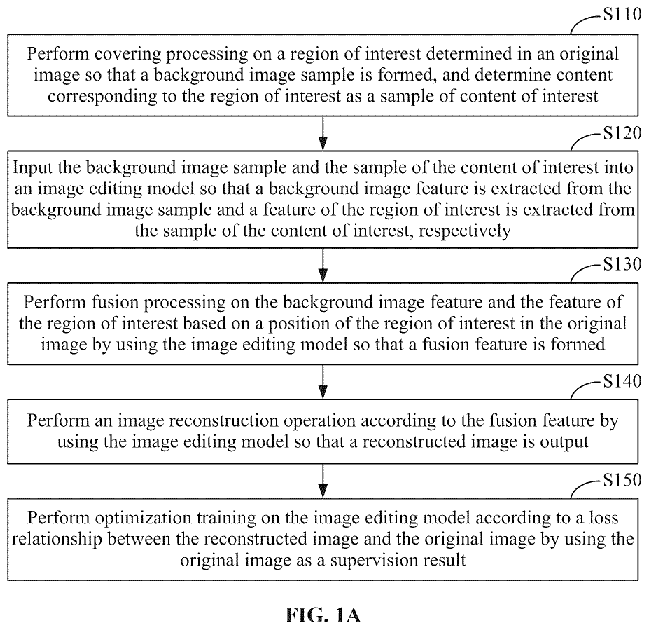

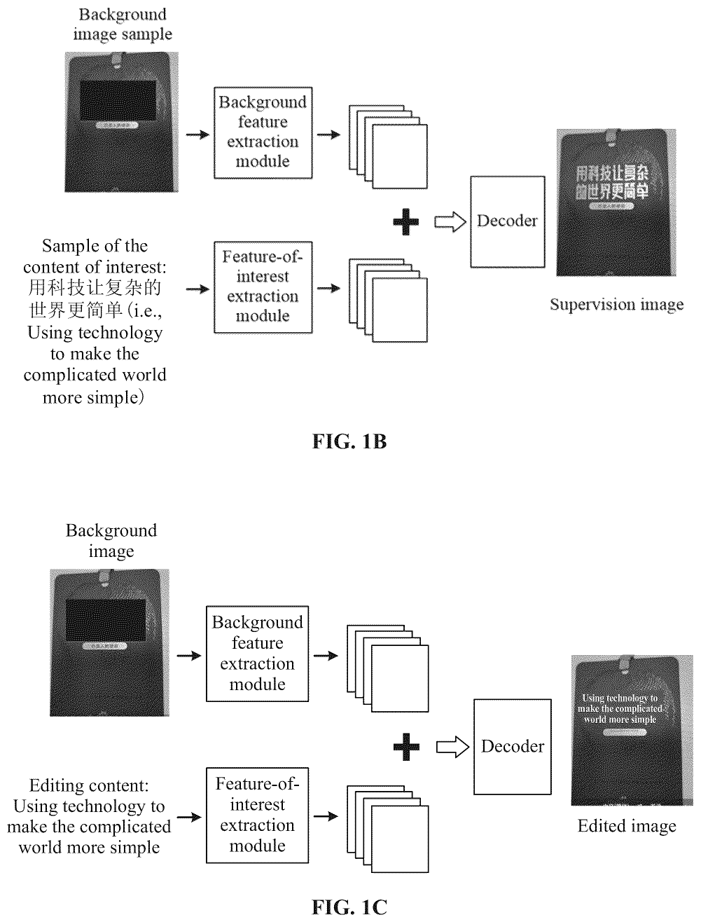

FIG. 1A is a schematic diagram of a method for training an image editing model according to an embodiment of the present disclosure. The embodiment of the present disclosure is applicable to the case of training an image editing model through samples. The method is executable by an apparatus for training an image editing model. The apparatus may be implemented by hardware and/or software and may be configured in an electronic device. Referring to FIG. 1A, the method includes steps described below.

In S110, covering processing is performed on a region of interest determined in an original image so that a background image sample is formed, and content corresponding to the region of interest is determined as a sample of content of interest.

In S120, the background image sample and the sample of the content of interest are input into an image editing model so that a background image feature is extracted from the background image sample and a feature of the region of interest is extracted from the sample of the content of interest, respectively.

In S130, fusion processing is performed on the background image feature and the feature of the region of interest based on a position of the region of interest in the original image by using the image editing model so that a fusion feature is formed.

In S140, an image reconstruction operation is performed according to the fusion feature by using the image editing model so that a reconstructed image is output.

In S150, optimization training is performed on the image editing model according to a loss relationship between the reconstructed image and the original image by using the original image as a supervision result.

The original image is an image having a region needing to be edited, and the region of interest is an image region where content needing to be edited is located in the original image. Editing the image may include changing, replacing or deleting the original content, and may include adding new content to the region of interest. The image editing model is configured to perform content editing on text, specific image content such as facial features or a blank region in an image according to requirements. Typical examples of text editing are, for example, translation of text or specific text hiding.

In an embodiment, the region of interest needing to be edited in the original image is determined, and image content in the region of interest is used as the sample of the content of interest. The region of interest in the original image is covered by a mask so that the background image sample is formed, and the masked background image sample can be recognized by the image editing model since the covered region of the background image sample is significantly different from the non-covered region of the background image sample. A feature extraction module exists in the image editing model and is configured to perform feature extraction on the background image sample and the sample of the content of interest which are input into the image editing model so that the background image feature of the background image sample and the feature of the region of interest of the sample of the content of interest are obtained.

When the background image feature and the feature of the region of interest are fused, the fusion is performed based on the position of the region of interest in the original image, so that the image editing model can learn the position relationship between the region of interest and the background image when trained. Accordingly, the fusion feature includes not only the information of the region of interest and the information of the background image, but also the information of the relative position of the region of interest and the background image.

The fusion feature is decoded by a decoder in the image editing model. After the fusion feature is decoded, a reconstructed sample is obtained through the fusion of the sample of the content of interest and a background image sample. Since the sample of the content of interest and the background image sample are both obtained based on the background image, the optimal reconstructed image of the sample of the content of interest and the background image sample should be the original image; at this time, the original image may be used as a supervision image of the reconstructed image. The loss relationship between the reconstructed image and the original image characterizes the error generated when the image editing model processes and reconstructs content of the region of interest and an image of other region except the region of interest in the image reconstruction process. To-be-trained parameters in the image editing model are adjusted based on the feedback of the loss relationship so that the optimization training on the image editing model is achieved.

The sample of the content of interest and the background image sample are generated by using the original image, and thus the original image can be used as the supervision result of the reconstructed image to train the image editing model. In this manner, requirements for paired samples of the image editing model in the training process are lowered and the source of sample data sets used in the training of the image editing model is enriched.

The embodiment of the present disclosure solves the problem of the dependence of the image editing model on real data, and training samples are formed in the manner that the original image is split. After the content of the region of interest in the original image is split, sample features of the two parts of the content are extracted, respectively, fused and then used for training, so that the association between the features of the two parts can be learned by the image editing model. Thus, when the original content of the region of interest needs to be edited with other content, the image editing model can also feed back the association between the two parts of the content. According to the embodiment of the present disclosure, the difficulty and costs of acquiring samples are effectively reduced, and data marking requirements for training data sets are simplified, so that large-scale data training can be driven, and the generalization of the image editing model is really achieved in real scenes.

In an optional embodiment, the sample of the content of interest includes text or a set content image, and the set content image includes a human face image or a human body image.

In an embodiment, if the image content in the region of interest is text, the sample of the content of interest is the content of the text. At this time, image editing may be editing manners such as text content translation and font enlarging. If the image content in the region of interest is non-text content, the sample of the content of interest may be a set content image. When the set content image is a human face image, image editing at this time may be image editing manners such as artificial intelligence (AI) face changing and identification photo generation for the human face image in the region of interest. When the set content image is a human body image, the image editing may be image editing manners such as virtual reality (VR) try-on of clothes for the human body. Different types of samples of the content of interest are set, so that the image editing model can complete the training under different editing requirements, such as text operation, AI face changing, VR try-on of clothes for the human body, etc.

In an optional embodiment, the image editing model trained completely is configured to enter the background image, editing content and a position of the region of interest in a to-be-edited image to generate an edited target image, where the editing content is used for editing processing on an image of the region of interest.

In an embodiment, when the image editing model is used, the background image formed by covering the region of interest in the to-be-edited image, the editing content provided for modifying the image content in the region of interest and the position of the region of interest in the to-be-edited image are input into the model, and the image editing model fuses the editing content with the background image according to the position of the region of interest in the to-be-edited image to obtain an image editing result. The editing content input into the image editing model is controlled to replace the image content in the region of interest of the to-be-edited image, so that the usability and universality of the image editing model are improved.

Exemplarily, FIG. 1B is a schematic diagram showing the flow of training an image editing model according to an embodiment of the present disclosure. FIG. 1C is a schematic diagram showing the flow of using an image editing model according to an embodiment of the present disclosure. During the training of the image editing model, text [symbol] in the original image is the content of interest, the text is used as the sample of the content of interest, and the region of interest where the text is located is covered to obtain the background image sample. Feature extraction, fusion and reconstruction are sequentially performed on the sample of the content of interest and the background image sample through the image editing model to obtain the reconstructed image. The reconstructed image is compared with the original image used as the supervision result, the loss relationship may be calculated based on a set loss function, and then optimization training is performed on the image editing model based on the loss relationship. When the image editing model is used, if the text of the content of interest [symbol] in the to-be-processed image is to be translated into English, the region of interest where the text is located is covered so that the background image is obtained, the English translation “Using technology to make the complicated world more simple” of the text is used as the editing content, the editing content and the background image are input into the image editing model, and the output result of the image editing model is an edited image. Chinese [symbol] in the to-be-processed image is successfully translated into English “Using technology to make complicated world more simple” in the edited result, and the edited result is correctly displayed in the region of interest.

In an optional embodiment, the editing content includes at least one of: blank content, translated text of a set language of original text in the region of interest; a replacement image of an original image in the region of interest; or new text or a new image which is to be added to the region of interest.

In an embodiment, if the editing content input into the image editing model is blank content, the type of image editing at this time is deleting the image content in the region of interest. If the editing content input into the image editing model is translated text of a set language, the type of image editing at this time is translating the text in the region of interest into text of the set language. If the editing content input into the image editing model is a replacement image of the original image in the region of interest, the type of image editing at this time is replacing the original image in the region of interest with the replacement image. If the editing content input into the image editing model is new text or a new image which is to be added to the region of interest, the type of image editing at this time is inserting text or an image into the to-be-processed image. Different editing content enables the image editing model to satisfy multiple requirements for image editing, so that the usability of the image editing model is improved.

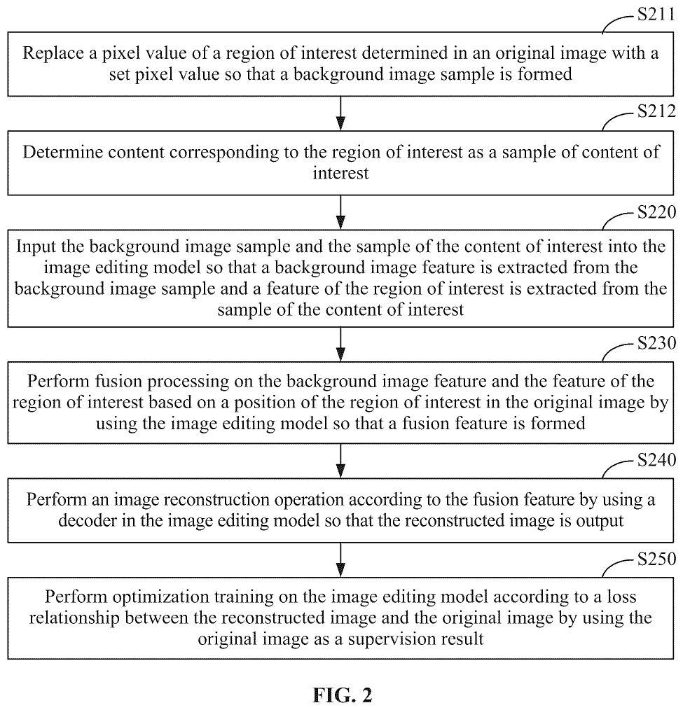

FIG. 2 is a flowchart of a method for training an image editing model according to another embodiment of the present disclosure. The embodiment is optimized and improved based on the preceding embodiment. As shown in FIG. 2, the method includes steps described below.

In S211, a pixel value of a region of interest determined in an original image is replaced with a set pixel value so that a background image sample is formed.

The set pixel value includes: a self-learning pixel value of an image editing model, a fixed pixel value or a random pixel value; and the set pixel value has a set rule to be distinguished from a rule of a pixel value outside the region of interest in the original image.

The self-learning pixel value of the image editing model refers to a pixel value, learned by the image editing model in the training process according to the difference between a reconstructed image and the original image, which enables the difference between a covered region and a non-covered region to be obvious and is easy to learn.

In an embodiment, an original pixel value of the region of interest in the original image is replaced with the set pixel value, and the set pixel value is used as covering for the region of interest to form the background image sample. The set pixel value may be any one of the self-learning pixel value of the image editing model, the fixed pixel value or the random pixel value. Whatever kind the set pixel value is, the set pixel value should have a set rule; the set rule is different from a background rule of the background image part so that the replaced pixel value of the covered region is significantly different from the pixel value of the surrounding background image region. The image editing model can determine the position of the background image and the position of the covered part according to the obvious difference between pixel values, and can learn the covered region without marking the position of the covered region. For the pristine original image, the pixel value of the background image satisfies the expression requirements of the image content, and no obvious numerical variation rule exists. The replacement pixel value of the covered region is a set pixel value having an obvious change rule, so that it is convenient for the image editing model to recognize these two regions.

In S212, content corresponding to the region of interest is determined as a sample of content of interest.

In S220, the background image sample and the sample of the content of interest are input into the image editing model; a background image feature is extracted from the background image sample by using a background feature extraction module in the image editing model; and a feature of the region of interest is extracted from the sample of the content of interest by using a feature-of-interest extraction module in the image editing model.

In an embodiment, two branches exist in the image editing model. Feature encoding is performed on the background image sample through the background feature extraction module so that the background image feature is obtained, and feature encoding is performed on the sample of the content of interest through the feature-of-interest extraction module so that the feature of the region of interest is obtained. The feature of the region of interest and the background image feature are extracted through different feature extraction modules in the image editing model respectively so that specific extraction parameters of different content are separately learned.

Optionally, in response to the sample of the content of interest being text, the feature-of-interest extraction module is configured to extract a text semantic feature; in response to the sample of the content of interest being a set content image, the feature-of-interest extraction module is configured to extract an image semantic feature.

In an embodiment, a great difference exists between the feature of the text and the feature of the image, and accordingly, manners for extracting the feature of the text and the feature of the image should be adjusted. For the text, the text semantic feature of the text content should be extracted through the feature-of-interest extraction module, while for the image, the image semantic feature of the set content image should be extracted through the feature-of-interest extraction module, so that the image editing model is trained to maintain good editing effects on both the text and the content image.

In S230, fusion processing is performed on the background image feature and the feature of the region of interest based on a position of the region of interest in the original image by using the image editing model so that a fusion feature is formed.

In S240, an image reconstruction operation is performed according to the fusion feature by using a decoder in the image editing model so that the reconstructed image is output.

In an embodiment, feature extraction performed by the feature extraction module in the image editing model equals to an encoding operation; therefore, the fusion feature of the background image feature and the feature of the region of interest needs to be decoded so that the reconstructed image can be obtained. The decoder in the image editing model receives the fusion feature and then performs upsampling decoding to obtain the reconstructed image having the same size as the original image as the output of the image editing model. Feature encoding is performed on the background image sample and a sample of the content of interest, and decoding is performed after feature fusion, so that the sample of the content of interest and the background image sample can be fused quickly, and thus the editing efficiency of the image editing model is improved.

In S250, optimization training is performed on the image editing model according to a loss relationship between the reconstructed image and the original image by using the original image as a supervision result.

In the embodiment of the present disclosure, it is set that the pixel value of the covered region has the set rule to be distinguished from the rule of the pixel value outside the region of interest in the original image, so that the image editing model can determine the position of the background image and the position of the covered part according to the obvious difference between pixel values without marking the position of the covered region. The feature of the region of interest and the background image feature are extracted through different feature extraction modules in the image editing model, respectively, so that capabilities of the image editing model learning the feature of the region of interest and the background image feature are improved.

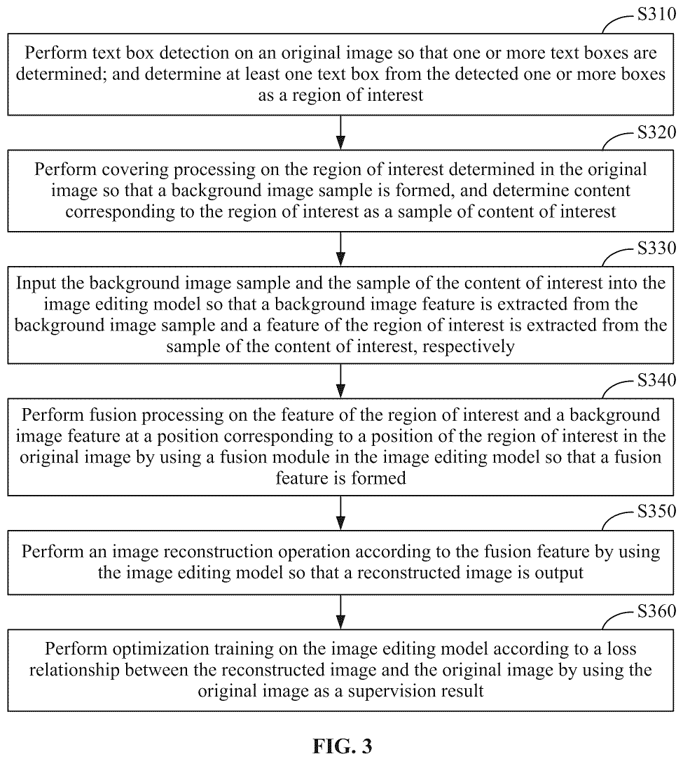

FIG. 3 is a flowchart of a method for training an image editing model according to another embodiment of the present disclosure. The embodiment is optimized and improved based on the preceding embodiments. As shown in FIG. 3, the method includes steps described below.

In S310, text box detection is performed on an original image so that one or more text boxes are determined; and at least one text box is determined from the detected one or more boxes as a region of interest.

In an embodiment, whether text content exists in the original image may be detected through text recognition technologies such as the optical character recognition (OCR) technology. If text content exists in the original image, the position of each piece of text in the original image is marked in the manner of a text box, and each text box may be used as a region of interest. Text box detection is performed on the original image before training, and the text box is used as the region of interest, so that regions of interest in the original image are enriched, and an image editing model can be trained repeatedly based on different regions of interest in one original image, which improves the training efficiency of the image editing model.

Optionally, the step in which at least one text box is determined from the detected one or more boxes as the region of interest includes the step described below.

The at least one text box is determined from the detected one or more boxes as the region of interest based on user selection or a set selection rule.

In an embodiment, when multiple text boxes exist in the original image, a text box selected from the multiple text boxes by the user may be used as the region of interest; or text box attributes such as text confidence of the multiple text boxes and text clarity of the multiple text boxes may be detected according to the set selection rule, and a text box of which the attribute detection result satisfies the set selection rule is selected from the multiple text boxes as the region of interest. The text boxes are filtered manually or through the set selection rule, so that the impact of invalid text boxes as regions of interest on the training effect of the image editing model is avoided.

Optionally, the set selection rule includes that text confidence of a text box satisfies a set condition.

In an embodiment, the text confidence refers to the confidence that the image content in a text box is real text. For the text box detected by using the text box detection technology, omission and misrecognition of the text content in the image are inevitable. To avoid that non-text content in the image is mistakenly recognized as text content, the text confidence of each text box is acquired. If the text confidence of a text box does not satisfy the set condition for text confidence in the set selection rule, the text box will not be used as the region of interest. Detected text boxes are filtered through the text confidence of the text boxes, so that the authenticity and effectiveness of the region of interest are improved.

In S320, covering processing is performed on the region of interest determined in the original image so that a background image sample is formed, and content corresponding to the region of interest is determined as a sample of content of interest.

In S330, the background image sample and the sample of the content of interest are input into the image editing model so that a background image feature is extracted from the background image sample and a feature of the region of interest is extracted from the sample of the content of interest, respectively.

In S340, fusion processing is performed on the feature of the region of interest and a background image feature at a position corresponding to a position of the region of interest in the original image by using a fusion module in the image editing model so that a fusion feature is formed.

In an embodiment, the fusion module learns the position of the region of interest in the original image according to the position of the covered part in the background image, and fuses the feature of the region of interest and the background image feature whose positions match based on the learned position of the region of interest in the original image to form the fusion feature. The position of the region of interest in the original image is learned and used when the feature of the region of interest and the background image feature are fused so that the corresponding positions of the feature of the region of interest and the background image feature are fused, and therefore the training effect of the image editing model is improved.

Optionally, the sample of the content of interest is text; a background feature extraction module is a convolutional neural network model, and the extracted background image feature is a two-dimensional feature map; a feature-of-interest extraction module is a text feature extraction model, and an extracted text semantic feature is a one-dimensional vector of a character.

The text feature extraction model may be a Bidirectional Encoder Representations from Transformers (BERT) structure or an Enhanced Representation through Knowledge Integration (ERNIE) structure; and the text feature extraction model may be a convolutional neural network (CNN) or a Vision Transformer (ViT) structure.

In an embodiment, the background image sample and the sample of the content of interest are an image and text, respectively, and therefore the feature dimensions extracted by the feature extraction module from the background image sample and the sample of the content of interest are also different. The feature obtained from the feature extraction processing performed by the background feature extraction module on the background image sample is a two-dimensional feature map of the background image; and the feature obtained from the feature extraction performed by the feature-of-interest extraction module on the sample of the content of interest is a one-dimensional vector of a character in the sample of the content of interest.

Optionally, the step in which fusion processing is performed on the feature of the region of interest and the background image feature at the position corresponding to the position of the region of interest in the original image by using the fusion module in the image editing model so that the fusion feature is formed includes the step described below.

The one-dimensional vector of the character is spliced or added to a corresponding position of a two-dimensional feature map of the region of interest by using the fusion module in the image editing model to perform the fusion processing so that the fusion feature is formed.

Addition refers to feature addition of the same pixel point, and splicing refers to feature end-to-end connection of the same pixel point.

In an embodiment, a semantic feature of text is extracted from the text through the module as a one-dimensional vector of a character, and the one-dimensional vector of the character is filled into the corresponding position in the image so that a two-dimensional map of the semantic feature is formed. Feature end-to-end connection of the same pixel point or feature addition of the same pixel point is performed on the two-dimensional map of the semantic feature and the two-dimensional feature map of the background image so that feature fusion is achieved and the fusion feature is formed. The one-dimensional vector of the character and the two-dimensional feature map of the background image are fused in the manner of splicing or addition, so that the original information of the one-dimensional vector of the character and the two-dimensional feature map of the background image is retained to the maximum extent in the process of feature fusion, and thus the information loss in the process of image fusion is reduced.

Exemplarily, referring to FIG. 1B, the background feature extraction module is configured to encode a context visual feature of an entire image (the size of the entire image is N*3*H*W), and the obtained feature has the general size of N*C*h*w. The feature-of-interest extraction module is configured to perform feature encoding on the text content, and the obtained feature vector may be represented as N*C*1*1. To align the feature dimension with the visual feature dimension, the feature is directly expanded to have the same dimension of N*C*h*w as the visual feature. A decoder receives the fusion feature from the visual feature and the text feature, and then performs an upsampling operation to generate an image having the size of N*3*H*W.

Optionally, before the one-dimensional vector of the character is spliced or added to the corresponding position of the two-dimensional feature map of the region of interest, the step described below is further included.

In a case where it is determined that the sample of the content of interest includes multiple characters, averaging processing is performed on one-dimensional vectors of the multiple characters by using the fusion module in the image editing model so that a one-dimensional vector of an averaged character is formed.

In an embodiment, when the text has multiple characters, averaging processing is performed on one-dimensional vectors of all characters to form a one-dimensional vector of an averaged character, and fusion with the two-dimensional feature map is performed based on the one-dimensional vector of the averaged character.

Exemplarily, when multiple characters exist in one text box, the semantic feature vector of each character may be recognized through semantic recognition. For this text box, averaging processing may be performed on semantic feature vectors of all characters so that a unified text semantic feature is formed. The text semantic feature is fused to each pixel point of the text box at the corresponding position of the background image feature.

In S350, an image reconstruction operation is performed according to the fusion feature by using the image editing model so that a reconstructed image is output.

In S360, optimization training is performed on the image editing model according to a loss relationship between the reconstructed image and the original image by using the original image as a supervision result.

In the embodiment of the present disclosure, text boxes are filtered manually or through the set selection rule, so that the impact of invalid text boxes as regions of interest on the training effect of the image editing model is avoided, or that multiple training samples can be generated based on different text boxes of the same original image. The position of the region of interest in the original image is learned and used when the feature of the region of interest and the background image feature are fused, so that the accurate fusion of the feature of the region of interest and the background image feature is achieved, and the training effect of the image editing model is improved.

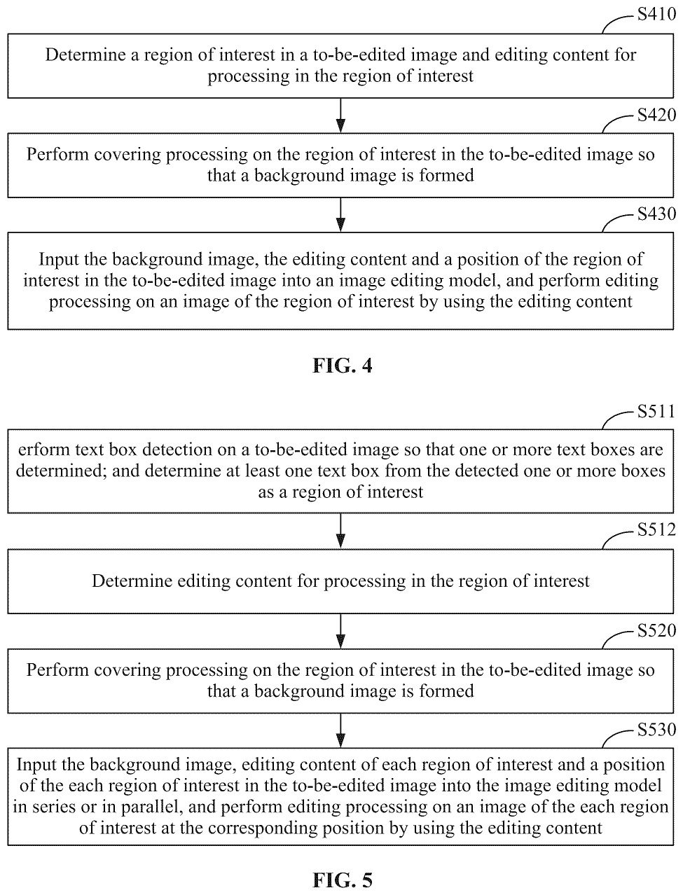

FIG. 4 is a schematic diagram of a method for editing an image according to an embodiment of the present disclosure. The embodiment of the present disclosure is applicable to the case of editing a to-be-processed image (i.e., to-be-edited image) through an image editing model. The method is executable by an apparatus for editing an image. The apparatus may be implemented by hardware and/or software and may be configured in an electronic device. Referring to FIG. 4, the method includes steps described below.

In S410, a region of interest in a to-be-edited image and editing content for processing in the region of interest are determined.

In S420, covering processing is performed on the region of interest in the to-be-edited image so that a background image is formed.

In S430, the background image, the editing content and a position of the region of interest in the to-be-edited image are input into an image editing model, and editing processing is performed on an image of the region of interest by using the editing content.

The image editing model is obtained by training through the method for training an image editing model according to any embodiment of the present disclosure.

In an embodiment, a to-be-edited region in the to-be-edited image is determined as the region of interest, the region of interest in the to-be-edited image is covered, and the to-be-processed image of which the region of interest is covered is the background image. A distinct difference between the covered region in the background image and the other region in the background image, which shows the position of the region of interest in the to-be-edited image, is input into the image editing model; the background image, the editing content and the position of the region of interest in the to-be-edited image are input into the image editing model, and the editing content is edited to the covered region of interest in the background image by the image editing model. The image editing model is obtained by training through the method for training an image editing model according to any one of the preceding embodiments of the present disclosure.

In the embodiment of the present disclosure, a background image is formed after the to-be-processed image is covered, the background image, the editing content and the position of the region of interest in the to-be-edited image are together input into the image editing model so that the editing of the to-be-processed image is completed. Since the data marking requirements for the image editing model during the training are simplified, large-scale data training can be driven, so that the image editing model can complete the processing of various types of to-be-edited images according to the editing content, and thus the generalization of the image editing model in real scenes is achieved.

In an optional embodiment, the editing content includes at least one of: blank content, translated text of a set language of original text in the region of interest; a replacement image of an original image in the region of interest; or new text or a new image which is to be added to the region of interest.

In an embodiment, different editing content is set to enable the image editing model to satisfy multiple requirements for image editing, so that the usability of the image editing model is improved.

FIG. 5 is a flowchart of a method for editing an image according to another embodiment of the present disclosure. The embodiment is optimized and improved based on the preceding embodiment. As shown in FIG. 5, the method includes steps described below.

In S511, text box detection is performed on a to-be-edited image so that one or more text boxes are determined; and at least one text box is determined from the detected one or more boxes as a region of interest.

In an embodiment, if multiple text boxes having text content exist in the to-be-edited image, a text box may be selected as the region of interest from the multiple text boxes by the user, or a text box may be selected as the region of interest from the multiple text boxes by the device according to a set selection rule. The text box as the region of interest is selected when multiple text boxes exist in the to-be-processed image, so that the multiple text boxes are prevented from interfering with each other when image editing is performed.

In S512, editing content for processing in the region of interest is determined.

In S520, covering processing is performed on the region of interest in the to-be-edited image so that a background image is formed.

In S530, the background image, editing content of each region of interest and a position of the each region of interest in the to-be-edited image are input into the image editing model in series or in parallel, and editing processing is performed on an image of the each region of interest at the corresponding position by using the editing content.

In an embodiment, when multiple regions of interest exist in the to-be-edited image, the background image of various regions of interest, the editing content of various regions of interest and the positions of various regions of interest in the to-be-edited image may be input in series into the image editing model one by one so that image editing is performed on various regions of interest sequentially. Alternatively, a total region of interest may be determined according to multiple to-be-processed regions of interest, and then multiple pieces of editing content for replacing various sub-regions of interest in the total region of interest are input in parallel into the image editing model for processing; and when multiple sub-regions of interest exist in the total region of interest, specific positions of the sub-regions of interest in the total region of interest or in the to-be-processed image need to be input into the image editing model together so that the image editing model can effectively distinguish and process the multiple pieces of editing content input in parallel. Editing of multiple regions of interest in the to-be-processed image is rapidly completed in the serial or parallel manner, so that the editing efficiency of the image editing model is improved.

In the embodiment of the present disclosure, the text box as the region of interest is selected when multiple text boxes exist in the to-be-processed image, so that the multiple text boxes are prevented from interfering with each other when image editing is performed. Editing of multiple regions of interest in the to-be-processed image is rapidly completed in the serial or parallel manner, so that the editing efficiency of the image editing model is improved.

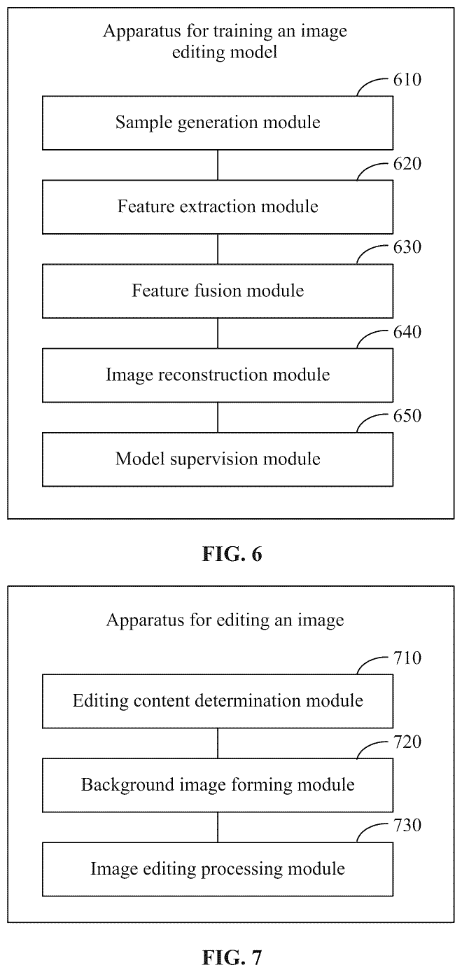

FIG. 6 is a structural diagram of an apparatus for training an image editing model according to an embodiment of the present disclosure. As shown in FIG. 6, the apparatus includes a sample generation module 610, a feature extraction module 620, a feature fusion module 630, an image reconstruction module 640 and a model supervision module 650.

The sample generation module 610 is configured to perform covering processing on a region of interest determined in an original image to form a background image sample, and determine content corresponding to the region of interest as a sample of content of interest.

The feature extraction module 620 is configured to input the background image sample and the sample of the content of interest into an image editing model to extract a background image feature from the background image sample and a feature of the region of interest from the sample of the content of interest, respectively.

The feature fusion module 630 is configured to perform fusion processing on the background image feature and the feature of the region of interest based on a position of the region of interest in the original image by using the image editing model to form a fusion feature.

The image reconstruction module 640 is configured to perform an image reconstruction operation according to the fusion feature by using the image editing model to output a reconstructed image.

The model supervision module 650 is configured to perform optimization training on the image editing model according to a loss relationship between the reconstructed image and the original image by using the original image as a supervision result.

The apparatus for training an image editing model provided in the embodiment of the present disclosure can execute the method for training an image editing model provided in any embodiment of the present disclosure and has function modules and beneficial effects corresponding to the executed method.

Optionally, the sample of the content of interest includes text or a set content image, and the set content image includes a human face image or a human body image.

Optionally, the sample generation module 610 includes a pixel replacement unit. The pixel replacement unit is configured to replace a pixel value of the region of interest determined in the original image with a set pixel value to form the background image sample. The set pixel value includes: a self-learning pixel value of the image editing model, a fixed pixel value or a random pixel value; and the set pixel value has a set rule to be distinguished from a rule of a pixel value outside the region of interest in the original image.

Optionally, the apparatus further includes a region-of-interest determination module. The region-of-interest determination module includes a text box detection unit and a first region-of-interest determination unit.

The text box detection unit is configured to perform text box detection on the original image to determine one or more text boxes.

The first region-of-interest determination unit is configured to determine at least one text box from the detected one or more boxes as the region of interest.

Optionally, the first region-of-interest determination unit is specifically configured to determine, based on user selection or a set selection rule, the at least one text box from the detected one or more boxes as the region of interest.

Optionally, the set selection rule includes that text confidence of a text box satisfies a set condition.

Optionally, the image reconstruction module 640 is specifically configured to perform an image reconstruction operation according to the fusion feature by using the image editing model to output a reconstructed image.

Optionally, the feature extraction module 620 is specifically configured to input the background image sample and the sample of the content of interest into the image editing model; extract the background image feature from the background image sample by using a background feature extraction module in the image editing model; and extract the feature of the region of interest from the sample of the content of interest by using a feature-of-interest extraction module in the image editing model.

Optionally, in response to the sample of the content of interest being text, the feature-of-interest extraction module is configured to extract a text semantic feature; in response to the sample of the content of interest being a set content image, the feature-of-interest extraction module is configured to extract an image semantic feature.

Optionally, the feature fusion module 630 is specifically configured to perform the fusion processing on the feature of the region of interest and a background image feature at a position corresponding to the position of the region of interest in the original image by using a fusion module in the image editing model to form the fusion feature.

Optionally, the sample of the content of interest is text; the background feature extraction module is a convolutional neural network model, and the extracted background image feature is a two-dimensional feature map; the feature-of-interest extraction module is a text feature extraction model, and an extracted text semantic feature is a one-dimensional vector of a character.

Optionally, the feature fusion module 630 is further configured to splice or add the one-dimensional vector of the character to a corresponding position of a two-dimensional feature map of the region of interest by using the fusion module in the image editing model to perform the fusion processing so as to form the fusion feature.

Optionally, the apparatus further includes a character vector averaging module. The character vector averaging module is configured to, in a case where it is determined that the sample of the content of interest includes multiple characters, perform averaging processing on one-dimensional vectors of the multiple characters by using the fusion module in the image editing model to form a one-dimensional vector of an averaged character.

Optionally, the image editing model trained completely is configured to enter a background image, editing content and a position of the region of interest in a to-be-edited image to generate an edited target image, where the editing content is used for editing processing on an image of the region of interest.

Optionally, the editing content includes at least one of: blank content, translated text of a set language of original text in the region of interest; a replacement image of an original image in the region of interest; or new text or a new image which is to be added to the region of interest.

The further described apparatus for training an image editing model can also execute the method for training an image editing model provided in any embodiment of the present disclosure and has function modules and beneficial effects corresponding to the executed method.

FIG. 7 is a structural diagram of an apparatus for editing an image according to an embodiment of the present disclosure. As shown in FIG. 7, the apparatus includes an editing content determination module 710, a background image forming module 720 and an image editing processing module 730.

The editing content determination module 710 is configured to determine a region of interest in a to-be-edited image and editing content for processing in the region of interest.

The background image forming module 720 is configured to perform covering processing on the region of interest in the to-be-edited image to form a background image.

The image editing processing module 730 is configured to input the background image, the editing content and a position of the region of interest in the to-be-edited image into an image editing model, and perform editing processing on an image of the region of interest by using the editing content.

The image editing model is obtained by training through the method for training an image editing model according to any embodiment of the present disclosure.

The apparatus for editing an image provided in the embodiment of the present disclosure can execute the method for editing an image provided in any embodiment of the present disclosure and has function modules and beneficial effects corresponding to the executed method.

Optionally, the image editing processing module 730 is specifically configured to input the background image, editing content of each region of interest and a position of the each region of interest in the to-be-edited image into the image editing model in series or in parallel, and perform the editing processing on an image of the each region of interest at the corresponding position by using the editing content.

Optionally, the editing content includes at least one of: blank content, translated text of a set language of original text in the region of interest; a replacement image of an original image in the region of interest; or new text or a new image which is to be added to the region of interest.

Optionally, the editing content determination module 710 includes a second region-of-interest determination unit. The second region-of-interest determination unit is configured to perform text box detection on the to-be-edited image to determine one or more text boxes; and determine at least one text box from the detected one or more boxes as the region of interest.

The further described apparatus for editing an image can also execute the method for editing an image provided in any embodiment of the present disclosure and has function modules and beneficial effects corresponding to the executed method.

In the technical solutions of the present disclosure, the collection, storage, use, processing, transmission, provision, and disclosure of user personal information involved conform to relevant laws and regulations and do not violate public order and good customs.

According to the embodiments of the present disclosure, the present disclosure further provides an electronic device, a readable storage medium and a computer program product.

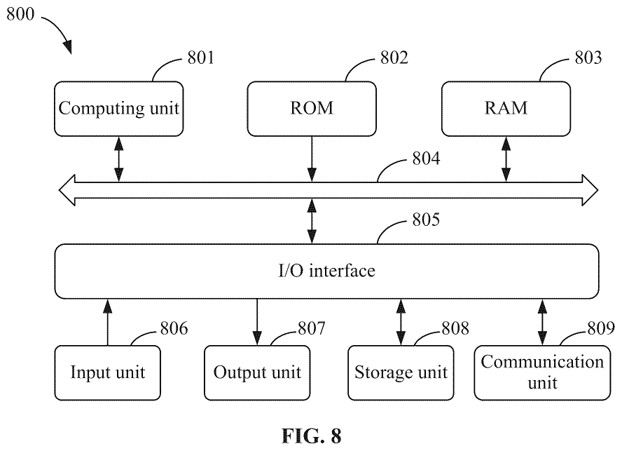

FIG. 8 is a block diagram of an example electronic device 800 that may be configured to implement an embodiment of the present disclosure. Electronic devices are intended to represent various forms of digital computers, for example, laptop computers, desktop computers, worktables, personal digital assistants, servers, blade servers, mainframe computers and other applicable computers. Electronic devices may further represent various forms of mobile apparatuses, for example, personal digital assistants, cellphones, smartphones, wearable devices and other similar computing apparatuses. Herein the shown components, the connections and relationships between these components and the functions of these components are illustrative only and are not intended to limit the implementation of the present disclosure as described and/or claimed herein.

As shown in FIG. 8, the device 800 includes a computing unit 801. The computing unit 801 may perform various types of appropriate operations and processing based on a computer program stored in a read-only memory (ROM) 802 or a computer program loaded from a storage unit 808 to a random-access memory (RAM) 803. Various programs and data required for operations of the device 800 may also be stored in the RAM 803. The computing unit 801, the ROM 802 and the RAM 803 are connected to each other through a bus 804. An input/output (I/O) interface 805 is also connected to the bus 804.

Multiple components in the device 800 are connected to the I/O interface 805. The components include an input unit 806 such as a keyboard and a mouse, an output unit 807 such as various types of displays and speakers, the storage unit 808 such as a magnetic disk and an optical disc, and a communication unit 809 such as a network card, a modem and a wireless communication transceiver. The communication unit 809 allows the device 800 to exchange information/data with other devices over a computer network such as the Internet and/or various telecommunications networks.

The computing unit 801 may be various general-purpose and/or special-purpose processing components having processing and computing capabilities. Examples of the computing unit 801 include, but are not limited to, a central processing unit (CPU), a graphics processing unit (GPU), a special-purpose artificial intelligence (AI) computing chip, a computing unit executing machine learning models and algorithms, a digital signal processor (DSP) and any appropriate processor, controller and microcontroller. The computing unit 801 executes various methods and processing described above, such as the method for training an image editing model or the method for editing an image. For example, in some embodiments, the method for training an image editing model or the method for editing an image may be implemented as a computer software program tangibly contained in a machine-readable medium such as the storage unit 808. In some embodiments, part or all of computer programs may be loaded and/or installed on the device 800 via the ROM 802 and/or the communication unit 809. When the computer programs are loaded into the RAM 803 and executed by the computing unit 801, one or more steps of the preceding method for training an image editing model or the preceding method for editing an image may be executed. Alternatively, in other embodiments, the computing unit 801 may be configured, in any other suitable manner (for example, by means of firmware), to execute the method for training an image editing model or the method for editing an image.

Herein various embodiments of the systems and techniques described above may be implemented in digital electronic circuitry, integrated circuitry, field-programmable gate arrays (FPGAs), application-specific integrated circuits (ASICs), application-specific standard products (ASSPs), systems on chips (SOCs), complex programmable logic devices (CPLDs), computer hardware, firmware, software and/or combinations thereof. The various embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input apparatus and at least one output apparatus and transmitting the data and instructions to the memory system, the at least one input apparatus and the at least one output apparatus.

Program codes for the implementation of the methods of the present disclosure may be written in one programming language or any combination of multiple programming languages. The program codes may be provided for the processor or controller of a general-purpose computer, a special-purpose computer or another programmable data processing apparatus to enable functions/operations specified in flowcharts and/or block diagrams to be implemented when the program codes are executed by the processor or controller. The program codes may be executed entirely on a machine, partly on a machine, as a stand-alone software package, partly on a machine and partly on a remote machine, or entirely on a remote machine or a server.

In the context of the present disclosure, the machine-readable medium may be a tangible medium that may include or store a program that is used by or used in conjunction with an instruction execution system, apparatus or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device or any appropriate combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM), a flash memory, an optical fiber, a portable compact disc read-only memory (CD-ROM), an optical storage device, a magnetic storage device or any suitable combination thereof.

In order that interaction with a user is provided, the systems and techniques described herein may be implemented on a computer. The computer has a display apparatus (for example, a cathode-ray tube (CRT) or a liquid-crystal display (LCD) monitor) for displaying information to the user and a keyboard and a pointing apparatus (for example, a mouse or a trackball) through which the user can provide input to the computer. Other types of apparatuses may also be used for providing interaction with a user. For example, feedback provided for the user may be sensory feedback in any form (for example, visual feedback, auditory feedback or haptic feedback). Moreover, input from the user may be received in any form (including acoustic input, voice input or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein) or a computing system including any combination of such back-end, middleware or front-end components. Components of a system may be interconnected by any form or medium of digital data communication (for example, a communication network). Examples of the communication network include a local area network (LAN), a wide area network (WAN), a blockchain network and the Internet.

The computing system may include clients and servers. The clients and the servers are usually far away from each other and generally interact through the communication network. The relationship between the clients and the servers arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in the service of a related physical host and a related virtual private server (VPS). The server may also be a server of a distributed system, or a server combined with a blockchain.

Artificial intelligence is a discipline studying the simulation of certain human thinking processes and intelligent behaviors (such as learning, reasoning, thinking and planning) by a computer and involves techniques at both hardware and software levels. Hardware techniques of artificial intelligence generally include techniques such as sensors, special-purpose artificial intelligence chips, cloud computing, distributed storage and big data processing. Software techniques of artificial intelligence mainly include several major directions such as computer vision technology, speech recognition technology, natural language processing technology, machine learning/deep learning technology, big data processing technology and knowledge graph technology.

Cloud computing refers to a technical system that accesses a shared elastic-and-scalable physical or virtual resource pool through a network and can deploy and manage resources in an on-demand self-service manner, where the resources may include servers, operating systems, networks, software, applications, storage devices and the like. Cloud computing can provide efficient and powerful data processing capabilities for model training and technical applications such as artificial intelligence and blockchains.

It is to be understood that various forms of the preceding flows may be used, with steps reordered, added or removed. For example, the steps described in the present disclosure may be executed in parallel, in sequence or in a different order as long as the desired result of the technical solutions provided in the present disclosure is achieved. The execution sequence of these steps is not limited herein.

The scope of the present disclosure is not limited to the preceding embodiments. It is to be understood by those skilled in the art that various modifications, combinations, sub-combinations and substitutions may be made depending on design requirements and other factors. Any modification, equivalent substitution, improvement and the like made within the spirit and principle of the present disclosure is within the scope of the present disclosure.

What is claimed is:

1. A method for training an image editing model, comprising:
performing covering processing on a region of interest determined in an original image to form a background image sample, and determining content corresponding to the region of interest as a sample of content of interest;
inputting the background image sample and the sample of the content of interest into an image editing model to extract a background image feature from the background image sample and a feature of the region of interest from the sample of the content of interest, respectively;
performing fusion processing on the background image feature and the feature of the region of interest based on a position of the region of interest in the original image by using the image editing model to form a fusion feature;
performing an image reconstruction operation according to the fusion feature by using the image editing model to output a reconstructed image; and
performing optimization training on the image editing model according to a loss relationship between the reconstructed image and the original image by using the original image as a supervision result.

2. The method according to claim 1, wherein performing the covering processing on the region of interest determined in the original image to form the background image sample comprises:
replacing a pixel value of the region of interest determined in the original image with a set pixel value to form the background image sample, wherein
the set pixel value comprises: a self-learning pixel value of the image editing model, a fixed pixel value or a random pixel value; and the set pixel value has a set rule to be distinguished from a rule of a pixel value outside the region of interest in the original image.

3. The method according to claim 1, before performing the covering processing on the region of interest determined in the original image, further comprising:
performing text box detection on the original image to determine one or more text boxes; and
determining at least one text box from the detected one or more boxes as the region of interest.

4. The method according to claim 3, wherein determining the at least one text box from the detected one or more boxes as the region of interest comprises:
determining, based on user selection or a set selection rule, the at least one text box from the detected one or more boxes as the region of interest.

5. The method according to claim 4, wherein the set selection rule comprises that text confidence of a text box satisfies a set condition.

6. The method according to claim 1, wherein performing the image reconstruction operation according to the fusion feature by using the image editing model to output the reconstructed image comprises:
performing the image reconstruction operation according to the fusion feature by using a decoder in the image editing model to output the reconstructed image.

7. The method according to claim 1, wherein inputting the background image sample and the sample of the content of interest into the image editing model to extract the background image feature from the background image sample and the feature of the region of interest from the sample of the content of interest, respectively comprises:
inputting the background image sample and the sample of the content of interest into the image editing model;
extracting the background image feature from the background image sample by using a background feature extraction module in the image editing model; and
extracting the feature of the region of interest from the sample of the content of interest by using a feature-of-interest extraction module in the image editing model.

8. The method according to claim 7, wherein in response to the sample of the content of interest being text, the feature-of-interest extraction module is configured to extract a text semantic feature; in response to the sample of the content of interest being a set content image, the feature-of-interest extraction module is configured to extract an image semantic feature.

9. The method according to claim 7, wherein performing the fusion processing on the background image feature and the feature of the region of interest based on the position of the region of interest in the original image by using the image editing model to form the fusion feature comprises:
performing the fusion processing on the feature of the region of interest and a background image feature at a position corresponding to the position of the region of interest in the original image by using a fusion module in the image editing model to form the fusion feature.

10. The method according to claim 9, wherein the sample of the content of interest is text; the background feature extraction module is a convolutional neural network model, and the extracted background image feature is a two-dimensional feature map; the feature-of-interest extraction module is a text feature extraction model, and the extracted text semantic feature is a one-dimensional vector of a character.

11. The method according to claim 10, wherein performing the fusion processing on the feature of the region of interest and the background image feature at the position corresponding to the position of the region of interest in the original image by using the fusion module in the image editing model to form the fusion feature comprises:
splicing or adding the one-dimensional vector of the character to a corresponding position of a two-dimensional feature map of the region of interest by using the fusion module in the image editing model to perform the fusion processing so as to form the fusion feature.

12. The method according to claim 11, before splicing or adding the one-dimensional vector of the character to the corresponding position of the two-dimensional feature map of the region of interest, further comprising:
in a case where it is determined that the sample of the content of interest comprises a plurality of characters, performing averaging processing on one-dimensional vectors of the plurality of characters by using the fusion module in the image editing model to form a one-dimensional vector of an averaged character.

13. The method according to claim 1, wherein the image editing model trained completely is configured to enter a background image, editing content and a position of the region of interest in a to-be-edited image to generate an edited target image, wherein the editing content is used for editing processing on an image of the region of interest.

14. The method according to claim 13, wherein the editing content comprises at least one of:
blank content;
translated text of a set language of original text in the region of interest;
a replacement image of an original image in the region of interest; or
new text or a new image which is to be added to the region of interest.

15. The method according to claim 1, wherein the sample of the content of interest comprises text or a set content image, and the set content image comprises a human face image or a human body image.

16. A method for editing an image, comprising:
determining at least one region of interest in a to-be-edited image and editing content for processing in the at least one region of interest;
performing covering processing on the at least one region of interest in the to-be-edited image to form a background image; and
inputting the background image, the editing content and a position of the at least one region of interest in the to-be-edited image into an image editing model, and performing editing processing on an image of the at least one region of interest by using the editing content;
wherein the image editing model is obtained by training through the method for training the image editing model according to claim 1.

17. The method according to claim 16, wherein in a case where the at least one region of interest comprises a plurality of regions of interest, inputting the background image, the editing content and the position of the at least one region of interest in the to-be-edited image into the image editing model, and performing the editing processing on the image of the at least one region of interest by using the editing content comprises:
inputting the background image, editing content of each region of interest of the plurality of regions of interest and a position of the each region of interest in the to-be-edited image into the image editing model in series or in parallel, and performing the editing processing on an image of the each region of interest at the corresponding position by using the editing content.

18. The method according to claim 16, wherein the editing content comprises at least one of:
blank content;
translated text of a set language of original text in the at least one region of interest;
a replacement image of an original image in the at least one region of interest; or
new text or a new image which is to be added to the at least one region of interest.

19. The method according to claim 16, wherein determining the region of interest in the to-be-edited image comprises:
performing text box detection on the to-be-edited image to determine one or more text boxes; and
determining at least one text box from the detected one or more boxes as the region of interest.

20. An electronic device, comprising:
at least one processor; and
a memory communicatively connected to the at least one processor;
wherein the memory stores instructions executable by the at least one processor to enable the at least one processor to execute the following steps:
performing covering processing on a region of interest determined in an original image to form a background image sample, and determining content corresponding to the region of interest as a sample of content of interest;
inputting the background image sample and the sample of the content of interest into an image editing model to extract a background image feature from the background image sample and a feature of the region of interest from the sample of the content of interest, respectively;
performing fusion processing on the background image feature and the feature of the region of interest based on a position of the region of interest in the original image by using the image editing model to form a fusion feature;
performing an image reconstruction operation according to the fusion feature by using the image editing model to output a reconstructed image; and
performing optimization training on the image editing model according to a loss relationship between the reconstructed image and the original image by using the original image as a supervision result.
